(19) United States
(12) Patent Application Publication
(10) Pub. No.: US 2025/0148760 A1
(43) Pub. Date: May 8, 2025

(54) IMAGE SEQUENCE DETECTION METHOD AND APPARATUS, MEDIUM, DEVICE, AND PROGRAM PRODUCT

(71) Applicant: Tencent Technology (Shenzhen) Company Limited, Shenzhen (CN)

(72) Inventor: Haoran QIAN, Shenzhen (CN)

(21) Appl. No.: 19/014,083

(22) Filed: Jan. 8, 2025

Related U.S. Application Data
(63) Continuation of application No. PCT/CN2023/131954, filed on Nov. 18, 2023.

(30) Foreign Application Priority Data
Jan. 17, 2023 (CN) 202310090615.7

(51) Int. Cl. G06V 10/764; G06V 10/80

(52) U.S. Cl. CPC G06V 10/764; G06V 10/806; G06V 2201/07

(57) ABSTRACT

This application discloses an image sequence detection method performed by an electronic device. The method includes: obtaining an initial image sequence, the initial image sequence including a target object; inputting the initial image sequence to a pretrained target detection model, to obtain a detection result sequence, the target detection model being obtained by inputting sample training data to an initial detection model to be trained for training, the sample training data including one set of sample feature information respectively extracted from one set of sample images, and each piece of sample feature information including feature information jointly determined by using one frame of sample image and a previous frame of sample image of the one frame of sample image; and determining a detection result corresponding to each image in the initial image sequence based on the detection result sequence, the detection result indicating a category of the target object.

### CROSS-REFERENCE TO RELATED APPLICATIONS

This application is a continuation application of PCT Patent Application No. PCT/CN2023/131954, entitled “IMAGE SEQUENCE DETECTION METHOD AND APPARATUS, MEDIUM, DEVICE, AND PROGRAM PRODUCT” filed on Nov. 16, 2023, which_claims priority to Chinese Patent Application No. 2023100906157, entitled “IMAGE SEQUENCE DETECTION METHOD AND APPARATUS, STORAGE MEDIUM, AND ELECTRONIC DEVICE” filed with the China National Intellectual Property Administration on Jan. 17, 2023, both of which are incorporated herein by reference in their entirety.

### FIELD OF THE TECHNOLOGY

This application relates to the field of computers, and specifically, to detection of an image sequence.

### BACKGROUND OF THE DISCLOSURE

Currently, only a current data feature extracted from an image is usually used for classification in an image sequence detection method. Only the current data feature extracted from the image but no related historical data feature is used for classification.

As a result, it is difficult to ensure accuracy of a classification algorithm in the related art. Therefore, the related art has the technical problem of low image sequence detection accuracy.

For the problem, no effective solution has been provided yet.

### SUMMARY

Embodiments of this application provide an image sequence detection method and apparatus, a storage medium, and an electronic device, to resolve at least the technical problem of low image sequence detection accuracy in the related art.

According to an aspect of the embodiments of this application, there is provided an image sequence detection method performed by an electronic device, the method including: obtaining an initial image sequence, the initial image sequence including a target object; inputting the initial image sequence to a pretrained target detection model, to obtain a detection result sequence; and determining a detection result corresponding to each image in the initial image sequence based on the detection result sequence, the detection result being configured for indicating a category of the target object.

According to still another aspect of the embodiments of this application, there is further provided a non-transitory computer-readable storage medium having computer programs stored therein. The computer programs, when executed by a processor of an electronic device, cause the electronic device to perform the aforementioned image sequence detection method.

According to still another aspect of the embodiments of this application, there is further provided an electronic device, including a memory and a processor. The memory has computer programs stored therein, and the processor is configured to perform the image sequence detection method by using the computer programs.

In the embodiments of this application, an initial image sequence is obtained, the initial image sequence including a target object. The initial image sequence is inputted to a pretrained target detection model, to obtain a detection result sequence. The target detection model is a detection model obtained by inputting sample training data to an initial detection model to be trained for training. The sample training data includes one set of sample feature information respectively extracted from one set of sample images, and a classification result and an evaluation parameter that correspond to each piece of sample feature information. The classification result indicates a classification category for one piece of sample feature information. The evaluation parameter indicates a reward corresponding to the classification category. The one set of sample images is one set of continuous frames of images. For an i^{th} frame of sample image in the one set of continuous frames of images, sample feature information of the i^{th} frame of sample image is jointly determined based on the i^{th} frame of sample image and an (i−1)^{th} frame of sample image. A detection result corresponding to each image in the initial image sequence is determined based on the detection result sequence. Since the (i−1)^{th} frame of sample image is introduced to determine the sample feature information of the i^{th} frame of sample image, a historical data feature in the image sequence is introduced to design a fusion manner and a decision scoring manner for the historical data feature and a current data feature for model training, and a desired output result can be obtained through prediction with a convergent model, implementing accurate classification of the inputted image sequence. This improves image sequence detection accuracy, and further resolves the technical problem of low image sequence detection accuracy in the related art.

In addition, classification decision is performed based on the historical data feature and the current data feature, so that model training is driven by using feature data. The use of a temporal correlation between data further improves algorithm accuracy, and reduces a computational amount, reducing impact on algorithm performance.

### BRIEF DESCRIPTION OF THE DRAWINGS

FIG. 1 is a schematic diagram of an application environment of an exemplary image sequence detection method according to an embodiment of this application.

FIG. 2 is a schematic flowchart of an exemplary image sequence detection method according to an embodiment of this application.

FIG. 3 is a schematic diagram of an exemplary image sequence detection method according to an embodiment of this application.

FIG. 4 is a schematic diagram of still another exemplary image sequence detection method according to an embodiment of this application.

FIG. 5 is a schematic diagram of still another exemplary image sequence detection method according to an embodiment of this application.

FIG. 6 is a schematic diagram of still another exemplary image sequence detection method according to an embodiment of this application.

FIG. 7 is a schematic diagram of still another exemplary image sequence detection method according to an embodiment of this application.

FIG. 8 is a schematic diagram of still another exemplary image sequence detection method according to an embodiment of this application.

FIG. 9 is a schematic diagram of still another exemplary image sequence detection method according to an embodiment of this application.

FIG. 10 is a schematic diagram of a structure of an exemplary image sequence detection apparatus according to an embodiment of this application.

FIG. 11 is a schematic diagram of a structure of an exemplary image sequence detection product according to an embodiment of this application.

FIG. 12 is a schematic diagram of a structure of an exemplary electronic device according to an embodiment of this application.

### DESCRIPTION OF EMBODIMENTS

In order to make a person skilled in the art better understand the solutions of this application, the following clearly and completely describes the technical solutions in the embodiments of this application with reference to the accompanying drawings in the embodiments of this application. It is clear that the described embodiments are merely some rather than all of the embodiments of this application. All other embodiments obtained by a person of ordinary skill in the art based on the embodiments of this application without creative efforts shall fall within the protection scope of this application.

In the specification, claims, and accompanying drawings of this application, the terms “first”, “second”, and the like are intended to distinguish between similar objects but do not necessarily indicate a specific order or sequence. Data termed in such a way is interchangeable in proper circumstances, so that the embodiments of this application described herein can be implemented in other orders than the order illustrated or described herein. In addition, the terms “include” and “have” and any other variants are intended to cover a non-exclusive inclusion. For example, a process, method, system, product, or device that includes a list of operations or units is not necessarily limited to those expressly listed operations or units, but may include other operations or units not expressly listed or inherent to such a process, method, product, or device.

First, some nouns or terms used in the description of the embodiments of this application are suitable for the following explanations.

Target detection algorithm: detects, extracts, and recognizes a target object in an image sequence, to obtain a motion parameter of the target object, for example, a location, a speed, an acceleration, and a motion trajectory, thereby performing further processing and analysis for comprehending a behavior of the target object to complete a higher-level detection task.

The following describes this application with reference to the embodiments.

According to an aspect of the embodiments of this application, there is provided an image sequence detection method. In this embodiment, the image sequence detection method may be applied to a hardware environment shown in FIG. 1 including a server 101 and a terminal 103. As shown in FIG. 1, the server 101 is connected to the terminal 103 over a network, and may be configured to provide a service for the terminal or an application installed on the terminal. The application may be a video application, an instant messaging application, a browser application, an educational application, a game application, or the like. A database 105 may be disposed on the server or independently of the server, to provide a data storage service for the server 101, for example, a game data storage server. The network may include but is not limited to a wired network and a wireless network. The wired network includes a local area network, a metropolitan area network, and a wide area network. The wireless network includes Bluetooth, Wi-Fi, and another network implementing wireless communication. The terminal 103 may be a terminal configured with an application, and may include but is not limited to at least one of the following: a mobile phone (such as an Android phone and an iOS phone), a notebook computer, a tablet computer, a palmtop computer, a mobile Internet device (MID), a portable Android device (PAD), a desktop computer, a smart television, an intelligent voice interaction device, a smart home appliance, an on-board terminal, an aircraft, a virtual reality (VR for short) terminal, an augmented reality (AR for short) terminal, a mixed reality (MR for short) terminal, or another computer device. The server may be a single server, a server cluster including a plurality of servers, or a cloud server.

Refer to FIG. 1. The image sequence detection method may be implemented on the terminal 103 by using the following operations:
S1: Obtain, on the terminal 103, an initial image sequence, the initial image sequence including a target object.
S2: Input, on the terminal 103, the initial image sequence to a pretrained target detection model, to obtain a detection result sequence, the target detection model being a detection model obtained by inputting sample training data to an initial detection model to be trained for training, the sample training data including one set of sample feature information respectively extracted from one set of sample images, and a classification result and an evaluation parameter that correspond to each piece of sample feature information, the classification result indicating a classification category for one piece of sample feature information, the evaluation parameter indicating a reward corresponding to the classification category, the one set of sample images being one set of continuous frames of images, and for an i^{th} frame of sample image in the one set of continuous frames of images, sample feature information of the i^{th} frame of sample image being jointly determined based on the i^{th} frame of sample image and an (i−1)^{th} frame of sample image.
S3: Determine, on the terminal 103, a detection result corresponding to each image in the initial image sequence based on the detection result sequence, the detection result being configured for indicating a category of the target object.

In this embodiment, the image sequence detection method may alternatively be implemented by a computer device, for example, the server, for example, the server 101 shown in FIG. 1, or is jointly implemented by the terminal and the server.

The description is merely an example, which is not specifically limited in this embodiment.

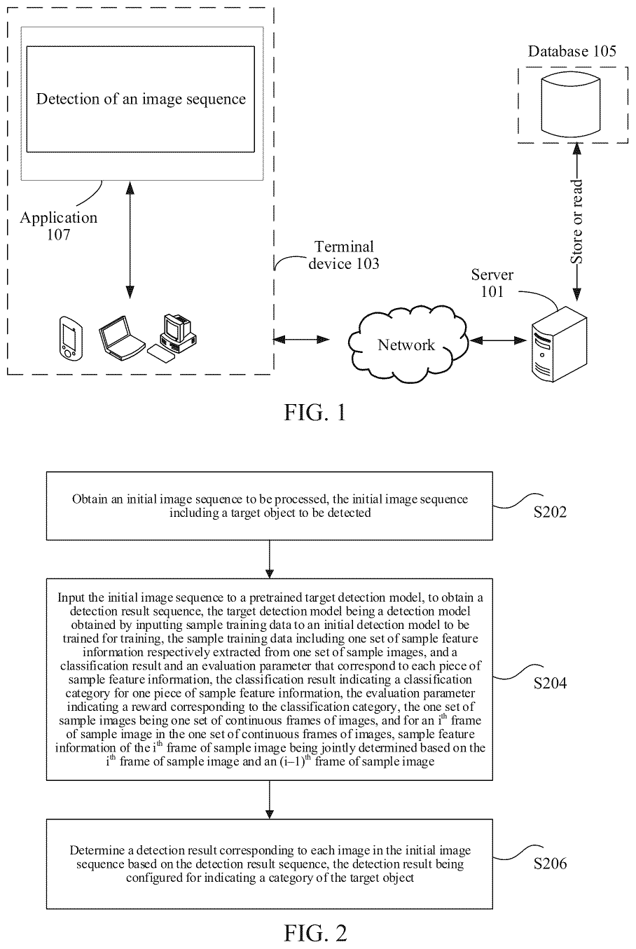

In some embodiments, as an exemplary implementation, as shown in FIG. 2, the image sequence detection method includes the following operations:
S202: Obtain an initial image sequence, the initial image sequence including a target object.

In this embodiment, the image sequence detection method may be applied to, but not limited to, virtual reality, augmented reality, mixed reality, and a conventional image sequence detection scenario, to detect a target object from an image sequence and determine a category of the target object.

In an exemplary embodiment, the target object may include but is not limited to a palm, an eye, and a whole body in a VR scenario or an AR scenario, and may further include but is not limited to a virtual animal, a virtual human body, and a virtual prop in the conventional detection scenario.

In this embodiment, the initial image sequence includes but is not limited to an image sequence to be recognized including a set of continuous frames of images, the image sequence including the target object, so that the initial image sequence is inputted to a target detection model, to obtain a detection result corresponding to the target object.

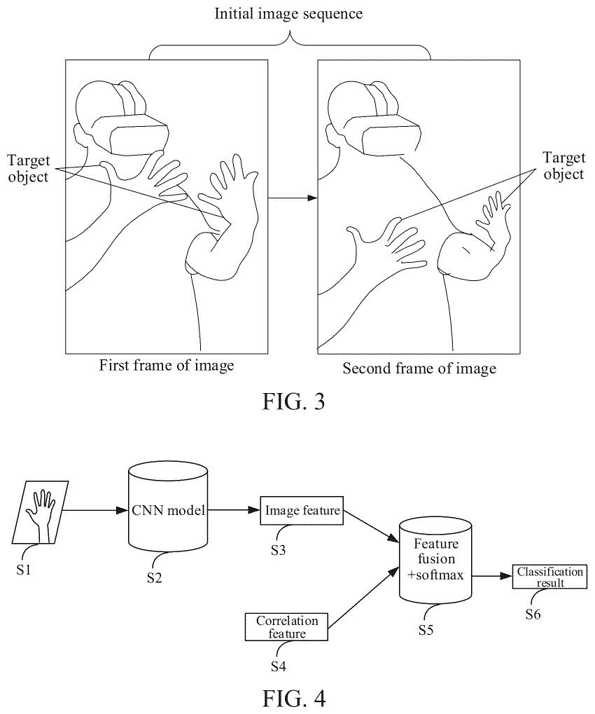

For example, FIG. 3 is a schematic diagram of an exemplary image sequence detection method according to an embodiment of this application. As shown in FIG. 3, the initial image sequence to be detected is included. Each of a first frame of image and a second frame of image in the initial image sequence includes the target object. The target object shown in FIG. 3 is a palm. The initial image sequence is detected to determine whether the target object is a left hand or a right hand.
S204: Input the initial image sequence to a pretrained target detection model, to obtain a detection result sequence, the target detection model being a detection model obtained by inputting sample training data to an initial detection model to be trained for training, the sample training data including one set of sample feature information respectively extracted from one set of sample images, and a classification result and an evaluation parameter that correspond to each piece of sample feature information, the classification result indicating a classification category for one piece of sample feature information, the evaluation parameter indicating a reward corresponding to the classification category, the one set of sample images being one set of continuous frames of images, and for an i^{th} frame of sample image in the one set of continuous frames of images, sample feature information of the i^{th} frame of sample image being jointly determined based on the i^{th} frame of sample image and an (i−1)^{th} frame of sample image.

For ease of description, in subsequent embodiments, the i^{th} frame of sample image is denoted as a current sample image, and the (i−1)^{th} frame of sample image is denoted as a previous frame of sample image.

In this embodiment, the target detection model may include but is not limited to a detection model obtained through training with a classical algorithm deep Q-learning in reinforcement learning, to implement classification of the target object in an image sequence detection process. Historical information in the image sequence is introduced to design a fusion manner and a decision scoring manner for historical feature information and current feature information for model training, and a final convergent model is the target detection model.

For example, FIG. 4 is a schematic diagram of another exemplary image sequence detection method according to an embodiment of this application. As shown in FIG. 4, a running process of the target detection model includes the following operations:
S1: Input the initial image sequence.
S2: Input a frame of image in the initial image sequence to a convolutional neural network (CNN) model, and perform feature extraction to obtain image feature information.
S3: Determine correlation feature information based on the frame of image and a previous frame of image of the frame of image.
S4: Perform a feature fusion and normalization operation (softmax operation) on the image feature information and the correlation feature information.
S5: Output a classification result.

The description is merely an example, which is not specifically limited in this embodiment. An order of the operations is not fixed, and may be flexibly adjusted based on an actual requirement.

In this embodiment, the detection result sequence includes but is not limited to a sequence including a plurality of detection results, and one detection result corresponds to one image in the initial image sequence, i.e., the number of images included in the initial image sequence is the same as the number of detection results finally outputted to form the detection result sequence.

In an exemplary embodiment, one detection result may be configured for indicating whether the target object is detected from a corresponding image, and a category of the target object when the target object is detected. For example, when a detection objective is to determine whether the palm is a left hand or a right hand, an initial image sequence including palms is inputted to obtain a detection result sequence indicating whether a palm in each frame of image is the left hand or the right hand.

In this embodiment, the initial detection model is an incompletely trained detection model. An initial parameter of the detection model is preset by staff through, but not limited to, random initialization. A parameter of the detection model is adjusted after each round of training in a training process, until a training objective is achieved. The training objective may include but is not limited to a preset training round count threshold and a loss function of the detection model satisfying a preset condition.

In this embodiment, the sample training data may be understood as a training data set obtained by a training data arrangement module through arrangement. Each piece of sample training data includes one set of sample feature information respectively extracted from one set of sample images, and a classification result and an evaluation parameter corresponding to each piece of sample feature information, i.e., there may be, but not limited to, one or more pieces of sample training data. In a case that there are a plurality of pieces of sample training data, each piece of sample training data corresponds to one set of sample images, and different sample training data may correspond to different sets of sample images.

One piece of sample feature information in the one set of sample feature information corresponds to one sample image in the one set of sample images, i.e., the sample training data includes sample feature information extracted from each sample image in the one set of sample images, and a corresponding classification result and evaluation parameter.

In an exemplary embodiment, the classification result indicates a classification category outputted after one piece of sample feature information is inputted to the initial detection model, and the evaluation parameter indicates a reward corresponding to the classification category.

The evaluation parameter may be understood as a reward parameter in deep Q-learning in reinforcement learning, and is configured to evaluate whether the classification category is as expected. Whether the classification category is as expected may be understood as whether the classification category is the same as a classification result indicated by a related label.

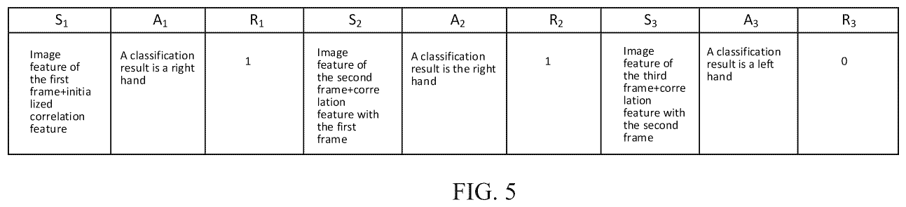

For example, FIG. 5 is a schematic diagram of still another exemplary image sequence detection method according to an embodiment of this application. As shown in FIG. 5, one set of sample images include 3 sample images, and the one set of sample images are inputted to the initial detection model, to obtain classification results and evaluation parameters for three continuous frames.

Details are as follows. In a case that the 3 sample images inputted are all of the right hand, a classification result for the first frame indicates the right hand, a classification result for the second frame indicates the right hand, and a classification result for the third frame indicates the left hand. In this case, S_1 indicates a feature of the first frame of image and an initialized correlation feature, A_1 indicates that the classification result for the first frame of image is the right hand, and R_1 indicates that an evaluation parameter for the first frame of image is 1; S_2 indicates a feature of the second frame of image and a correlation feature with the first frame of image, A_2 indicates that the classification result for the second frame of image is the right hand, and R_2 indicates that an evaluation parameter for the second frame of image is 1; and S_3 indicates a feature of the third frame of image and a correlation feature with the second frame of image, A_3 indicates that the classification result for the third frame of image is the left hand, and R_3 indicates that an evaluation parameter for the third frame of image is −1.

The one set of sample images is one set of continuous frames of images, i.e., a previous frame of image of each frame of image is in temporal correlation with the frame of image. In this case, the sample feature information may be jointly determined based on one frame of sample image and a previous frame of sample image of the frame of sample image.
S206: Determine a detection result corresponding to each image in the initial image sequence based on the detection result sequence, the detection result being configured for indicating a category of the target object.

In this embodiment, each detection result in the detection result sequence is in one-to-one correspondence to each image in the initial image sequence. Therefore, the detection result corresponding to each image may be determined in subsequent processing based on the detection result sequence, to perform subsequent processing based on the detection result.

For example, a VR system is used as an example. Many detection algorithms are applied to VR, for example, a gesture detection algorithm, an eye detection algorithm, and a whole body detection algorithm. These detection algorithms are configured for human-computer interaction in a VR device. The gesture detection algorithm is an important stage in the VR device, and is a cornerstone of a gesture operation in the VR device. The gesture operation has the advantages of more natural experience and more immersive experience in a scenario such as physical simulation interaction, and is a promising VR input manner. With the gesture detection algorithm, a location of a gesture may be identified, the gesture is further recognized in real time, and some basic operations, for example, aiming, selection, movement, rotation, and scaling, may be performed based on detection results of these gestures. For another example, the eye detection algorithm is used as an example. Basic operations such as control over an eye movement, aiming, and viewing may be performed.

The description is merely an example, which is not specifically limited in this embodiment.

According to the embodiment of this application, an initial image sequence is obtained, the initial image sequence including a target object. The initial image sequence is inputted to a pretrained target detection model, to obtain a detection result sequence. The target detection model is a detection model obtained by inputting sample training data to an initial detection model to be trained for training. The sample training data includes one set of sample feature information respectively extracted from one set of sample images, and a classification result and an evaluation parameter that correspond to each piece of sample feature information. The classification result indicates a classification category for one piece of sample feature information. The evaluation parameter indicates a reward corresponding to the classification category. The one set of sample images is one set of continuous frames of images. Each piece of sample feature information includes feature information jointly determined by using one frame of sample image and a previous frame of sample image of the one frame of sample image. The detection result corresponding to each image in the initial image sequence is determined based on the detection result sequence. The detection result is configured for indicating a category of the target object. In this way, a historical data feature in the image sequence is introduced to design a fusion manner and a decision scoring manner for the historical data feature and a current data feature for model training, and a desired output result can be obtained through prediction with a convergent model, implementing accurate classification of the inputted image sequence. This improves image sequence detection accuracy, and further resolves the technical problem of low image sequence detection accuracy in the related art.

As an exemplary solution, the method further includes: performing a first feature extraction operation on the one set of sample images, to obtain a first set of feature information, feature information in the first set of feature information being in one-to-one correspondence to sample images in the one set of sample images; performing a second feature extraction operation on the one set of sample images, to obtain a second set of feature information, first feature information in the second set of feature information being in one-to-one correspondence to the sample images in the one set of sample images, and the first feature information of the i^{th} frame of sample image indicating a correlation feature between the i^{th} frame of sample image and the (i−1)^{th} frame of sample image; and fusing the first set of feature information and the second set of feature information respectively, to obtain the one set of sample feature information.

In this embodiment, the first feature extraction operation may include but is not limited to an image feature extraction operation based on a CNN. Feature extraction is performed on each sample image in the one set of sample images, to obtain feature information corresponding to each sample image, to form the first set of feature information.

In this embodiment, the second feature extraction operation may include but is not limited to obtaining key point data of each frame of image and key point data of a previous frame of image of each frame of image, and calculating a distance between corresponding key points, to obtain the second set of feature information.

In this embodiment, the fusing the first set of feature information and the second set of feature information respectively, to obtain the one set of sample feature information may include but is not limited to fusing feature information in the first set of feature information and the second set of feature information corresponding to the same sample image. A fusion manner may include but is not limited to concatenation and addition after interpolation.

In an exemplary embodiment, the fusion procedure includes fusing feature information in the first set of feature information corresponding to an i^{th} sample image and feature information in the second set of feature information corresponding to the i^{th} sample image, to obtain sample feature information corresponding to the i^{th} sample image, and by analogy, obtaining the one set of sample feature information, i being a positive integer.

Feature information of a sample image and a correlation feature with a previous frame of sample image are extracted respectively through different feature extraction operations, and sample feature information corresponding to the sample image is obtained based on fusion. In this way, a historical data feature of the sample image is accurately and effectively fused to the sample feature information of the sample image, laying a foundation for subsequent category recognition.

As an exemplary solution, for the i^{th} frame of sample image, the performing a second feature extraction operation on the one set of sample images, to obtain a second set of feature information includes: performing an image recognition operation on the i^{th} frame of sample image, to determine a first set of key points, the first set of key points being configured for describing a location of the target object in the i^{th} frame of sample image; performing an image recognition operation on the (i−1)^{th} frame of sample image, to determine a second set of key points, the second set of key points being configured for describing a location of the target object in the (i−1)^{th} frame of sample image; and determining the first feature information of the i^{th} frame of sample image based on the first set of key points and the second set of key points, the first feature information of the i^{th} frame of sample image being configured for indicating a distance between corresponding key points in the first set of key points and the second set of key points.

In this embodiment, the first set of key points may be key points recognized from the current sample image by using an image detection algorithm, and the second set of key points may be key points recognized from the previous frame of sample image of the current sample image by using the image detection algorithm.

In an exemplary embodiment, an example in which the target object is a palm is used. A Euclidean distance between a current gesture and a gesture in the previous frame is calculated, and if key point information of n gestures is recognized, an n-dimensional correlation feature may be structured as the second set of feature information. One dimension of the n-dimensional correlation feature corresponds to one key point in the first set of key points and one key point in the second set of key points. In other words, the number of key points in the first set of key points may be the same as or different from the number of key points in the second set of key points. If the number of key points in the first set of key points is different from the number of key points in the second set of key points, a corresponding key point set is found from the set of key points with a larger number of key points by using the set of key points with a smaller number of key points. Correlation feature information of one dimension indicates a distance between corresponding key points.

A difference of the same target object between adjacent frames can accurately reflect a change of the target object between the (i−1)^{th} frame of sample image and the i^{th} frame of sample image, so that a more accurate correlation feature between the two frames of sample images is identified based on the dimension.

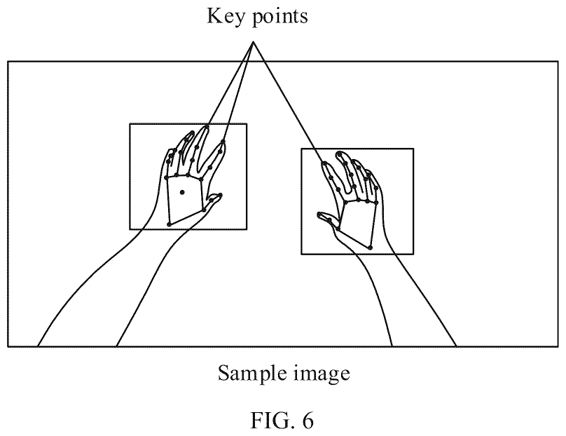

For example, an example in which the target object is a palm is used. FIG. 6 is a schematic diagram of still another exemplary image sequence detection method according to an embodiment of this application. As shown in FIG. 6, each palm has 21 key points, and space coordinates of each key point are represented by (x, y, z). (xᵢ, yᵢ, zᵢ) represents a key point in the current image, (xᵢ^{pre}, yᵢ^{pre}, zᵢ^{pre}) represents a key point in the previous frame of image, and \vec{V}=(v₁, v₂, v₃ . . . v₂₁) represents a distance between the key points:

$${v}_{n} = \sqrt[2]{[ {( {x}_{i} - {x}_{i}^{pre} )}^{2} + {( {y}_{i} - {y}_{i}^{pre} )}^{2} + {( {z}_{i} - {z}_{i}^{pre} )}^{2} ]} , ( 1 < = i < = 21 ) .$$

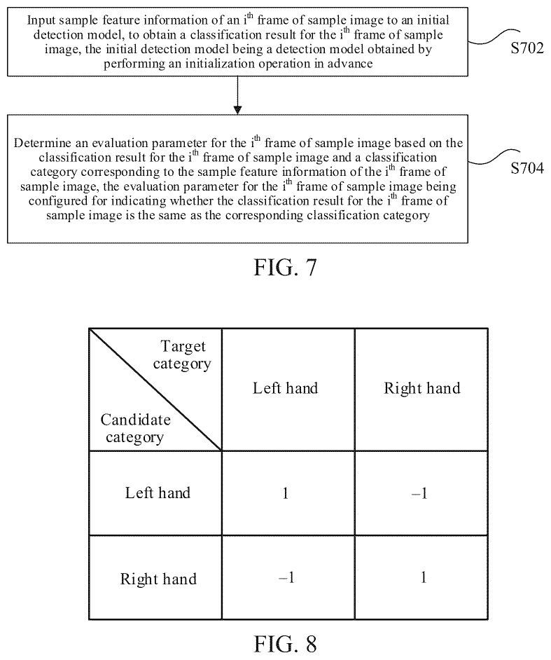

As an exemplary solution, FIG. 7 is a schematic diagram of still another exemplary image sequence detection method according to an embodiment of this application. As shown in FIG. 7, for the i^{th} frame of sample image, the method further includes the following operations:
S702: Input the sample feature information of the i^{th} frame of sample image to the initial detection model, to obtain a classification result for the i^{th} frame of sample image, the initial detection model being a detection model obtained by performing an initialization operation in advance.
S704: Determine an evaluation parameter for the i^{th} frame of sample image based on the classification result for the i^{th} frame of sample image and a classification category corresponding to the sample feature information of the i^{th} frame of sample image, the evaluation parameter for the i^{th} frame of sample image being configured for indicating whether the classification result for the i^{th} frame of sample image is the same as the corresponding classification category.

In this embodiment, the initial detection model is a detection model whose parameter is preset. Each time sample feature information is inputted, the initial detection model may output a classification result, and then compare the classification result with a classification category, to finally determine a current evaluation parameter.

As an exemplary solution, the inputting current sample feature information to the initial detection model, to obtain a current classification result in operation S702 includes:
inputting each category in a preset category set to a first preset function in sequence with the sample feature information of the i^{th} frame of sample image, to obtain a first set of function values, the first set of function values including a function value for each category relative to the sample feature information of the i^{th} frame of sample image; and
determining, as the classification result for the i^{th} frame of sample image, a candidate category corresponding to a first function value in the first set of function values that is the largest.

In this embodiment, the preset category set may be understood as a set of categories preset by the staff. In an example in which the target object is a gesture, the preset category set may include but is not limited to a left hand and a right hand. In an example in which the target object is an eye, the preset category set may include but is not limited to a left eye and a right eye.

In this embodiment, the first preset function may be set to aₜ=argmaxₐ Q(sₜ, a; θ), where aₜ indicates a category making an output of the model Q(sₜ, a; θ) largest, [symbol] indicates the initial detection model, sₜ indicates the current sample feature information, a indicates a category in the preset category set, and θ indicates a preset model parameter in the initial detection model.

Each category in the preset category set is inputted to the first preset function in sequence with the current sample feature information, and the candidate category corresponding to the largest function value of the first preset function is determined as the current classification result. For example, the target object is a gesture. The preset category set may include but is not limited to the left hand and the right hand, the left hand is inputted to the first preset function to obtain a score of 50, and the right hand is inputted to the first preset function to obtain a score of 90. In this case, the current classification result corresponding to the current sample feature information is the right hand. The description is merely an example.

In the embodiment of this application, a possible category of the target object may be selected from the preset category set in a plurality of classification manners, so that an application range of category recognition is enlarged.

As an exemplary solution, before operation S702, the method further includes: calculating a target random number in a preset manner; determining whether the target random number satisfies a preset probability condition; and selecting a candidate category randomly from the preset category set as the classification result for the i^{th} frame of sample image when the target random number satisfies the preset probability condition; or inputting the current sample feature information to the initial detection model, to obtain the current classification result when the target random number does not satisfy the preset probability condition.

In this embodiment, the preset manner may be implemented by using a preset code. A random number is randomly generated as the target random number in the preset manner. The preset probability condition is a condition determined based on a preset probability threshold. The preset probability threshold is flexibly set by the staff according to the actual requirement. If the target random number satisfies the preset probability condition, the target random number is within coverage of the preset probability condition.

For example, a random number 1 is randomly selected from 1 to 1000, and the preset probability threshold is set to 0.01. In this case, the preset probability condition is an interval of 1 to 10 in 1 to 1000. When the random number 1 is within the interval of 1 to 10, the target random number satisfies the preset probability condition, and in this case, a candidate category may be directly randomly selected from the preset category set as the current classification result. When a random number 11 is not within the interval of 1 to 10, the target random number does not satisfy the preset probability condition, and in this case, the current sample feature information is inputted to the initial detection model, to obtain the current classification result.

A specific proportion of category recognition may be implemented in a random manner based on the preset probability condition, where the proportion may be within a fault tolerance range of model training. Therefore, a computational amount of the initial detection model can be reduced to some extent, and model training efficiency can be improved.

As an exemplary solution, the determining, as the current classification result, a candidate category corresponding to a first function value in the first set of function values that is the largest in operation S702 includes: determining the evaluation parameter for the i^{th} frame of sample image as a first evaluation parameter when the candidate category corresponding to the first function value is the same as the classification category for the i^{th} frame of sample image, the first evaluation parameter indicating correct detection of the initial detection model; or determining the evaluation parameter for the i^{th} frame of sample image as a second evaluation parameter when the candidate category corresponding to the first function value is different from the classification category for the i^{th} frame of sample image, the second evaluation parameter indicating incorrect detection of the initial detection model.

In this embodiment, the classification category is specified by label information, i.e., the sample training data further includes a sample label corresponding to each sample image, and the sample label pre-annotates a true category of the target object in the sample image. In this case, whether the candidate category corresponding to the first function value is the same as a target category is determined to determine whether the initial detection model performs correct detection.

For example, FIG. 8 is a schematic diagram of still another exemplary image sequence detection method according to an embodiment of this application. As shown in FIG. 8, an example in which the target object is a palm is used. When the candidate category is a left hand, and the target category is also the left hand, the current evaluation parameter is a first evaluation parameter “1”; when the candidate category is a left hand, and the target category is a right hand, the current evaluation parameter is a second evaluation parameter “−1”; when the candidate category is a right hand, and the target category is also the right hand, the current evaluation parameter is a first evaluation parameter “1”; or when the candidate category is a right hand, and the target category is a left hand, the current evaluation parameter is a second evaluation parameter “−1”. The description is merely an example.

As an exemplary solution, the method further includes: selecting a plurality of sample data structures from the sample training data, a j^{th} sample data structure in the plurality of sample data structures including a j^{th} piece of sample feature information, a j^{th} classification result corresponding to the j^{th} piece of sample feature information, a j^{th} evaluation parameter, and a (j+1)^{th} piece of sample feature information, and j being a positive integer; and training the initial detection model to be trained based on the plurality of sample data structures, to obtain the target detection model, the initial detection model being determined as the target detection model when a round count of training the initial detection model reaches a preset round count threshold, or a model parameter of the initial detection model being adjusted based on a predetermined loss function when a round count of training the initial detection model does not reach the preset round count threshold, and an input for a training process of each round being one of the plurality of sample data structures.

In this embodiment, the sample data structure may include but is not limited to the sample feature information of the current frame, the classification result, the evaluation parameter, and sample feature information corresponding to a next frame of sample image, and may be represented by, but not limited to, (sⱼ, aⱼ, rⱼ, sⱼ₊₁), where sⱼ indicates the j^{th} piece of sample feature information, aⱼ indicates the j^{th} classification result corresponding to the j^{th} piece of sample feature information, r indicates the j^{th} evaluation parameter, and sⱼ₊₁ indicates the (j+1)^{th} piece of sample feature information.

The training the initial detection model to be trained based on the plurality of sample data structures, to obtain the target detection model may be understood as inputting the plurality of sample data structures in different rounds to the initial detection model for training, one sample data structure being inputted for training in each round. Training ends when the training round count reaches the preset round count threshold; or the parameter of the initial detection model is adjusted based on the value of the loss function by using a gradient descent method when the training round count does not reach the preset round count threshold.

The sample data structure can accurately associate sample data required for one training course, to perform model training in units of sample data structures, so that training efficiency can be effectively improved.

Both the preset round count threshold and the loss function are preset by the staff based on the actual requirement.

As an exemplary solution, for the j^{th} sample data structure, the training the initial detection model to be trained based on the plurality of sample data structures, to obtain the target detection model includes:
determining whether a sample image corresponding to the (j+1)^{th} piece of sample feature information is a last sample image in the sample image sequence;
determining, based on the j^{th} evaluation parameter when the sample image corresponding to the (j+1)^{th} piece of sample feature information is the last sample image, a preset parameter outputted by the initial detection model; or
determining the preset parameter based on the j^{th} evaluation parameter and an output of a reference detection model when the sample image corresponding to the (j+1)^{th} piece of sample feature information is not the last sample image, the reference detection model being a detection model obtained by performing an initialization operation in advance, and a parameter of the reference detection model being different from a parameter of the initial detection model;
determining a value of the loss function based on the preset parameter and an output of the initial detection model, and updating the parameter of the initial detection model based on the value of the loss function; and
determining the initial detection model as the target detection model when a round count of performing the above operations reaches the preset round count threshold.

In this embodiment, the sample feature information records an ending feature when the (j+1)^{th} piece of sample feature information is the sample feature information corresponding to the last sample image, i.e., whether the sample feature information corresponds to the last sample image may be determined based on the sample feature information.

In this embodiment, the preset parameter may be understood as a parameter configured to determine the value of the loss function. For example, the preset parameter is yⱼ. In this case, yⱼ is calculated. If one set of sample images end at j+1, yⱼ=rⱼ; or if one set of sample images do not end there, yⱼ=rⱼ+γ max_{a′} Q\hat{ }(sⱼ₊₁, a′; θ⁻), where γ is the preset parameter with a preset value that is usually 0.9, Q\hat{ }(sⱼ₊₁, a′; θ⁻) is the reference detection model whose parameter is different from the parameter of the initial detection model. sⱼ₊₁, a′ is inputted to the reference detection model, to determine a′ making an output of Q\hat{ } the largest.

In this embodiment, the determining a value of the loss function based on the preset parameter and an output of the initial detection model may be understood as defining the loss function as (yⱼ−Q(sⱼ, aⱼ; θ))², so that θ is updated by using the gradient descent method, to complete parameter update of the initial detection model.

As an exemplary solution, the determining a preset parameter based on the j^{th} evaluation parameter and an output of a reference detection model includes: inputting each category in a preset category set to a second preset function in sequence with the (j+1)^{th} piece of sample feature information, to obtain a second set of function values, the second set of function values including a function value corresponding to each category; and determining a sum of a second function value in the second set of function values that is the largest and the j^{th} evaluation parameter as the preset parameter.

In this embodiment, the second preset function is γ max_{a′} Q\hat{ }(sⱼ₊₁, a′; θ⁻). A sum of the largest function value of the second preset function and the j^{th} evaluation parameter is determined as the preset parameter, i.e., yⱼ=rⱼ+γ max_{a′} Q\hat{ }(sⱼ₊₁, a′; θ⁻).

This application is further described in detail with reference to the following specific examples.

In this solution, the target object is detected by using the classical algorithm deep Q-learning in reinforcement learning. Historical information in an image sequence is introduced to design a fusion manner and a decision scoring manner for historical feature information and current feature information for model training. A desired output result can be obtained through prediction with a convergent model.

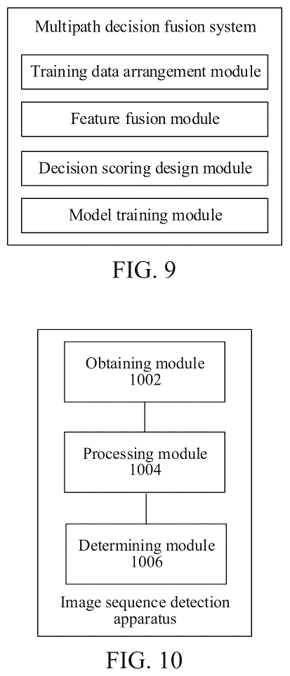

FIG. 9 is a schematic diagram of still another exemplary image sequence detection method according to an embodiment of this application. As shown in FIG. 9, a training data arrangement module, a feature fusion module, a decision scoring design module, and a model training module are mainly included.

The training data arrangement module arranges, in combination with the decision scoring design module, all historical data into a final format that can support model training.

The feature fusion module may extract a correlation between a historical image and a current image, converts the correlation into a correlation feature, fuses the correlation feature and current feature information, and finally inputs a fused feature into a network for training.

The decision scoring design module is configured to design a scoring rule for a true annotation result and a final classification decision, automatically generate scores for decisions in all the historical data, and annotate a score of each piece of historical data according to the rule.

The model training module uses training data generated by the training data arrangement module. An input of a training process is the current feature information and the correlation feature, and an output is a decision model for final classification.

### 1. The Training Data Arrangement Module

The data is arranged into S₁, A₁, R₂, S₂, A₂, R₃, . . . , S_{T-1}, A_{T-1}, R_{T}, S_{T}. An input is an image, and a location (coordinates) and category information (classification result) of an object to be detected in the image, as well as a corresponding label. One image corresponds to one label. S indicates a status. A indicates a decision (corresponding to the classification result). R indicates a score (corresponding to the evaluation parameter). S_{T} indicates an end state, labeling an end of an image sequence.

The following continues to give descriptions by using a gesture detection algorithm as an example.

S indicates the status, is outputted by the feature fusion module, and includes a current image feature and a correlation feature. A indicates a classification result. R indicates the score. S_{T} indicates the end state, labeling the end of the image sequence.

The inputted image is an image labeled as a right hand, the classification result being the right hand scores 1 point, and the classification result being a left hand scores −1 points.

The inputted image is an image labeled as a left hand, the classification result being a right hand scores −1 points, and the classification result being the left hand scores 1 point.

### 2. The Feature Fusion Module

First, a current input feature is extracted, and an image feature is extracted from an image of a gesture part via a deep neural network. For example, a 224*224 image is inputted, and an m-dimensional feature may be extracted via the network. Then, a correlation feature is calculated. A Euclidean distance between a current gesture and a gesture in a previous frame may be calculated. If there is key point information of n gestures, an n-dimensional correlation feature may be structured. Finally, the m-dimensional image feature and the n-dimensional correlation feature are fused (for example, through concatenation, or addition after interpolation), to obtain a final fused feature.

Image feature extraction: As shown in FIG. 4, fc8 is an extracted image feature.

Correlation feature: As shown in FIG. 4, each hand has 21 key points, and space coordinates of each key point are represented by (x, y, z). (xᵢ, yᵢ, zᵢ) represents a key point in the current image, (xᵢ^{pre}, yᵢ^{pre}, zᵢ^{pre}) represents a key point in the previous frame of image, and
\vec{V}=(v₁, v₂, v₃ . . . v₂₁) represents a distance between key points in adjacent frames of images, where

$${v}_{n} = \sqrt[2]{[ {( {x}_{i} - {x}_{i}^{pre} )}^{2} + {( {y}_{i} - {y}_{i}^{pre} )}^{2} + {( {z}_{i} - {z}_{i}^{pre} )}^{2} ]} , ( 1 < = i < = 21 ) .$$

### 3. The decision Scoring Design Module

A decision of a classification task is usually simple, and directly corresponds to a category of the classification task. For example, gesture detection involves the left hand and the right hand, a true annotation also involves the left hand and the right hand, and a combination of the true annotation and the final decision is mapped to a score L×A→R of a rational number. A result decision score F(l, a)→R, l∈L, a∈A is designed.

### 4. The Model Training Module

Q(s, a)→r, s∈S, a∈A, r∈R is learned, where [symbol] is the deep neural network.

A training procedure is as follows:
S1: Initialize a training data set D (with a fixed size of N), where N indicates an amount of data selected each time, D indicates a plurality of S₁, A₁, R₂, S₂, A₂, R₃, . . . , S_{T-1}, A_{T-1}, R_{T}, S_{T}, and N indicates the number of sequences selected each time.
S2: Initialize the neural network [symbol] (corresponding to the initial detection model) by using a random parameter θ.
S3: Initialize a target neural network Q\hat{ } (corresponding to the reference detection model) by using a parameter θ⁻=θ.
S4: Loop through all data from 1 to M, i.e., perform calculation on the 1^{st} piece of data to an M^{th} piece of data, where M is less than N.
S4-1: Obtain s₁ (for example, s₁ in the first sequence).
S4-1-1: Loop through the entire sequence 1 to T, where T indicates a length of the sequence.
S4-1-2: Calculate a random number (the random number may be understood as a probability outputted by the model, which is automatically generated) by using a code based on a probability ε (a preset parameter, for example, 0.01); and if the random number satisfies the preset probability parameter, randomly select an action aₜ (for example, randomly select 1 item from left\right); or if the random number does not satisfy the preset probability parameter, aₜ=argmaxₐ Q(sₜ, a; θ), inputting a state and an action, and outputting a score, where aₜ indicates an action (corresponding to the classification result) making the function largest.
S4-1-3: Obtain a score rₜ and a next state sₜ₊₁ based on aₜ.
S4-1-4: Store data (sₜ, aₜ, rₜ, sₜ₊₁) to D.
S4-2: Select a plurality of sets of data (sⱼ, aⱼ, rⱼ, sⱼ₊₁) from D.
S5: Calculate yⱼ; and if the data ends at j+1, yⱼ =rⱼ; or if the data does not end there, yⱼ=rⱼ+γ max_{a′} Q\hat{ }(sⱼ₊₁, a′; θ⁻), γ being a preset parameter with a preset value that is usually 0.9, and input sⱼ₊₁, a′, a′ indicating a making the output of Q\hat{ } the largest.
S6: Update θ in a gradient descent manner by using (yⱼ−Q(sⱼ, aⱼ; θ))² as a loss.
S7: Set Q\hat{ }=Q every C loops (C is less than M).

Optimal a is obtained by using a trained model based on s extracted from the current inputted image sequence, where a=argmaxₐᵢ Q (s, ai; θ).

According to this embodiment, first, a better classification decision can be made based on data in a data-driven manner. Second, a temporal correlation between data is well used by using a principle of reinforcement learning, so that algorithm accuracy is further improved. Finally, a computational amount in this embodiment is smaller than that in another method for processing temporal data through deep learning, so that impact on algorithm performance is reduced. For example, the gesture detection algorithm in VR can help improve gesture classification accuracy on the premise of introducing an extremely small additional computational amount.

Relevant data such as user information is involved in a specific implementation of this application. When the embodiments of this application are applied to a specific product or technology, a license or consent of a user is required to be obtained, and collection, use, and processing of the related data are required to comply with related laws and regulations and standards of related countries and regions.

For ease of description, the method embodiments are described as a series of action combinations. However, a person skilled in the art is to know that this application is not limited to the described order of the actions because some operations may be performed in another order or performed at the same time according to this application. In addition, a person skilled in the art is also to be aware that all embodiments described in this specification are exemplary embodiments, and the related actions and modules are not necessarily mandatory to this application.

According to another aspect of the embodiments of this application, there is further provided an image sequence detection apparatus for implementing the image sequence detection method. As shown in FIG. 10, the apparatus includes:
an obtaining module 1002, configured to obtain an initial image sequence, the initial image sequence including a target object;
a processing module 1004, configured to input the initial image sequence to a pretrained target detection model, to obtain a detection result sequence, the target detection model being a detection model obtained by inputting sample training data to an initial detection model to be trained for training, the sample training data including one set of sample feature information respectively extracted from one set of sample images, and a classification result and an evaluation parameter that correspond to each piece of sample feature information, the classification result indicating a classification category for one piece of sample feature information, the evaluation parameter indicating a reward corresponding to the classification category, the one set of sample images being one set of continuous frames of images, and for an i^{th} frame of sample image in the one set of continuous frames of images, sample feature information of the i^{th} frame of sample image being jointly determined based on the i^{th} frame of sample image and an (i−1)^{th} frame of sample image; and
a determining module 1006, configured to determine a detection result corresponding to each image in the initial image sequence based on the detection result sequence, the detection result being configured for indicating a category of the target object.

As an exemplary solution, the apparatus is further configured to: perform a first feature extraction operation on the one set of sample images, to obtain a first set of feature information, feature information in the first set of feature information being in one-to-one correspondence to sample images in the one set of sample images; perform a second feature extraction operation on the one set of sample images, to obtain a second set of feature information, first feature information in the second set of feature information being in one-to-one correspondence to the sample images in the one set of sample images, and the first feature information of the i^{th} frame of sample image indicating a correlation feature between the i^{th} frame of sample image and the (i−1)^{th} frame of sample image; and fuse the first set of feature information and the second set of feature information respectively, to obtain the one set of sample feature information.

As an exemplary solution, for the i^{th} frame of sample image, the apparatus is further configured to: perform an image recognition operation on the i^{th} frame of sample image, to determine a first set of key points, the first set of key points being configured for describing a location of the target object in the i^{th} frame of sample image; perform an image recognition operation on the (i−1)^{th} frame of sample image, to determine a second set of key points, the second set of key points being configured for describing a location of the target object in the (i−1)^{th} frame of sample image; and determine the first feature information of the i^{th} frame of sample image based on the first set of key points and the second set of key points, the first feature information of the i^{th} frame of sample image being configured for indicating a distance between corresponding key points in the first set of key points and the second set of key points.

As an exemplary solution, the apparatus is further configured to: input the sample feature information of the i^{th} frame of sample image to the initial detection model, to obtain a classification result for the i^{th} frame of sample image, the initial detection model being a detection model obtained by performing an initialization operation in advance; and determine an evaluation parameter for the i^{th} frame of sample image based on the classification result for the i^{th} frame of sample image and a classification category corresponding to the sample feature information of the i^{th} frame of sample image, the evaluation parameter for the i^{th} frame of sample image being configured for indicating whether the classification result for the i^{th} frame of sample image is the same as the corresponding classification category.

As an exemplary solution, the apparatus is configured to input current sample feature information to the initial detection model, to obtain a current classification result in the following manner: inputting each category in a preset category set to a first preset function in sequence with the sample feature information of the i^{th} frame of sample image, to obtain a first set of function values, the first set of function values including a function value for each category relative to the sample feature information of the i^{th} frame of sample image; and determining, as the classification result for the i^{th} frame of sample image, a candidate category corresponding to a first function value in the first set of function values that is the largest.

As an exemplary solution, the apparatus is further configured to: before inputting each category in the preset category set to the first preset function in sequence with the sample feature information of the i^{th} frame of sample image, to obtain the first set of function values, generate a target random number in a preset manner; determine whether the target random number satisfies a preset probability condition; and select a candidate category randomly from the preset category set as the classification result for the i^{th} frame of sample image when the target random number satisfies the preset probability condition; or input the current sample feature information to the initial detection model, to obtain the classification result for the i^{th} frame of sample image when the target random number does not satisfy the preset probability condition.

As an exemplary solution, the apparatus is configured to determine, as the classification result for the i^{th} frame of sample image in the following manner, a candidate category corresponding to a first function value in the first set of function values that is the largest: determining the evaluation parameter for the i^{th} frame of sample image as a first evaluation parameter when the candidate category corresponding to the first function value is the same as the classification category for the i^{th} frame of sample image, the first evaluation parameter indicating correct detection of the initial detection model; or determining the evaluation parameter for the i^{th} frame of sample image as a second evaluation parameter when the candidate category corresponding to the first function value is different from the classification category for the i^{th} frame of sample image, the second evaluation parameter indicating incorrect detection of the initial detection model.

As an exemplary solution, the apparatus is further configured to: select a plurality of sample data structures from the sample training data, a j^{th} sample data structure in the plurality of sample data structures including a j^{th} piece of sample feature information, a j^{th} classification result corresponding to the j^{th} piece of sample feature information, a j^{th} evaluation parameter, and a (j+1)^{th} piece of sample feature information, and j being a positive integer; and train the initial detection model to be trained based on the plurality of sample data structures, to obtain the target detection model, the initial detection model being determined as the target detection model when a round count of training the initial detection model reaches a preset round count threshold, or a model parameter of the initial detection model being adjusted based on a predetermined loss function when a round count of training the initial detection model does not reach the preset round count threshold, and an input for a training process of each round being one of the plurality of sample data structures.

As an exemplary solution, for the j^{th} sample data structure, the apparatus is further configured to: determine whether a sample image corresponding to the (j+1)^{th} piece of sample feature information is a last sample image in the sample image sequence; determine, based on the j^{th} evaluation parameter when the sample image corresponding to the (j+1)^{th} piece of sample feature information is the last sample image, a preset parameter outputted by the initial detection model; or determine the preset parameter based on the j^{th} evaluation parameter and an output of a reference detection model when the sample image corresponding to the (j+1)^{th} piece of sample feature information is not the last sample image, the reference detection model being a detection model obtained by performing an initialization operation in advance, and a parameter of the reference detection model being different from a parameter of the initial detection model; determine a value of the loss function based on the preset parameter and an output of the initial detection model, and update the parameter of the initial detection model based on the value of the loss function; and determine the initial detection model as the target detection model when a round count of performing the above operations reaches the preset round count threshold.

As an exemplary solution, the apparatus is configured to determine the preset parameter based on the j^{th} evaluation parameter and the output of the reference detection model in the following manner: inputting each category in a preset category set to a second preset function in sequence with the (j+1)^{th} piece of sample feature information, to obtain a second set of function values, the second set of function values including a function value corresponding to each category; and determining a sum of a second function value in the second set of function values that is the largest and the j^{th} evaluation parameter as the preset parameter.

According to an aspect of this application, there is provided a computer program product, including a computer program/instruction that include a program code for performing the method shown in the flowchart. In such an embodiment, the computer program may be downloaded and installed from a network through a communication part 1109, and/or installed from a removable medium 1111. When the computer program is executed by a central processing unit 1101, various functions provided in embodiments of this application are performed.

The sequence numbers of the embodiments of this application are merely for description and do not represent superiority-inferiority of the embodiments.

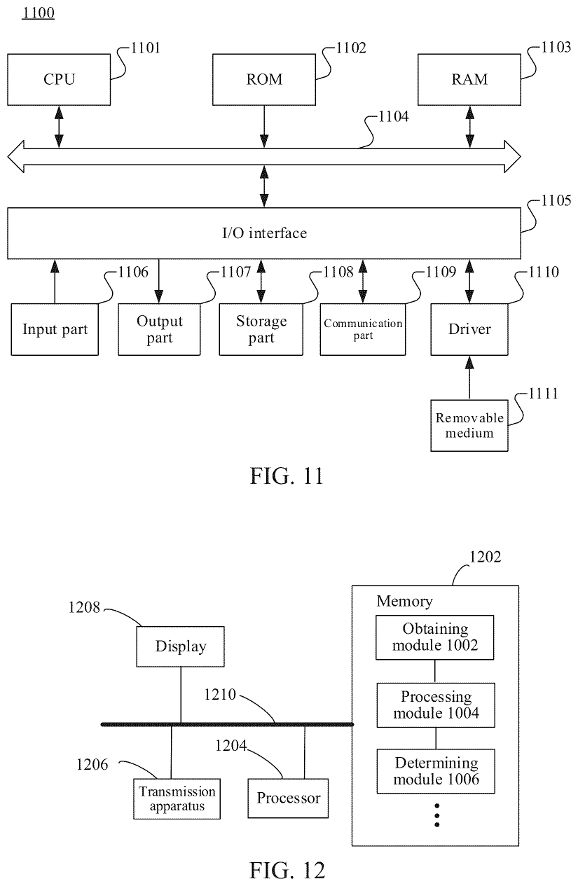

FIG. 11 is a block diagram of a structure of a computer system of an electronic device for implementing an embodiment of this application.

The computer system 1100 of the electronic device shown in FIG. 11 is merely an example, and does not constitute any limitation on the function and scope of use of the embodiments of this application.

As shown in FIG. 11, the computer system 1100 includes a central processing unit (CPU) 1101, which may perform various proper actions and processing based on a program stored in a read-only memory (ROM) 1102 or a program loaded from a storage part 1108 into a random access memory (RAM) 1103. The random access memory 1103 further stores various programs and data required by system operations. The central processing unit 1101, the read-only memory 1102, and the random access memory 1103 are connected to each other through a bus 1104. An input/output interface (i.e., an I/O interface) 1105 is also connected to the bus 1104.

The following components are connected to the input/output interface 1105: an input part 1106 including a keyboard, a mouth, and the like; an output part 1107 including, for example, a cathode ray tube (CRT), a liquid crystal display (LCD), and a speaker; the storage part 1108 including a hard disk and the like; and a communication part 1109 including, for example, a local area network card and a network interface card of a modem. The communication part 1109 performs communication processing via a network such as the Internet. A driver 1110 is also connected to the input/output interface 1105 as required. A removable medium 1111, such as a magnetic disk, an optical disc, a magneto-optical disk, or a semiconductor memory, is installed on the driver 1110 as required, so that a computer program read from the removable medium is installed into the storage part 1108 as required.

Particularly, according to an embodiment of this application, the processes described in each method flowchart may be implemented as a computer software program. For example, the embodiment of this application includes a computer program product, which includes a computer program carried on a computer-readable medium, where the computer program includes a program code for performing the method shown in the flowchart. In such an embodiment, the computer program may be downloaded and installed from a network through the communication part 1109, and/or installed from the removable medium 1111. When the computer program is executed by the central processing unit 1101, various functions defined in the system of this application are performed.

According to still another aspect of the embodiments of this application, there is further provided an electronic device for implementing the image sequence detection method. The electronic device may be the terminal or the server as shown in FIG. 1. In this embodiment, an example in which the electronic device is the terminal is used for description. As shown in FIG. 12, the electronic device includes a memory 1202 and a processor 1204. The memory 1202 has a computer program stored therein, and the processor 1204 is configured to perform operations in any of the method embodiments by using the computer program.

In this embodiment, the electronic device may be located in at least one of a plurality of network devices in a computer network.

In this embodiment, the processor may be configured to execute the computer program to perform the following operations:
S1: Obtain an initial image sequence, the initial image sequence including a target object.
S2: Input the initial image sequence to a pretrained target detection model, to obtain a detection result sequence, the target detection model being a detection model obtained by inputting sample training data to an initial detection model to be trained for training, the sample training data including one set of sample feature information respectively extracted from one set of sample images, and a classification result and an evaluation parameter that correspond to each piece of sample feature information, the classification result indicating a classification category for one piece of sample feature information, the evaluation parameter indicating a reward corresponding to the classification category, the one set of sample images being one set of continuous frames of images, and for an i^{th} frame of sample image in the one set of continuous frames of images, sample feature information of the i^{th} frame of sample image being jointly determined based on the i^{th} frame of sample image and an (i−1)^{th} frame of sample image.
S3: Determine a detection result corresponding to each image in the initial image sequence based on the detection result sequence, the detection result being configured for indicating a category of the target object.

In some embodiments, a person of ordinary skill in the art may understand that a structure shown in FIG. 12 is merely an example. The electronic device may alternatively be a terminal such as a smartphone (such as an Android mobile phone or an iOS mobile phone), a tablet computer, a palmtop computer, a mobile Internet device (MID), or a PAD. FIG. 12 does not constitute a limitation on the structure of the electronic device. For example, the electronic device may further include more or fewer components (for example, a network interface) than those shown in FIG. 12, or has a configuration different from that shown in FIG. 12.

The memory 1202 may be configured to store a software program and a module, such as program instructions/modules corresponding to the image sequence detection method and apparatus in the embodiments of this application. The processor 1204 performs various functional applications and data processing, i.e., implements the image sequence detection method, by running the software program and the module stored in the memory 1202. The memory 1202 may include a high-speed random memory, and may also include a non-volatile memory, for example, one or more magnetic storage apparatuses, a flash memory, or another nonvolatile solid-state memory. In some embodiments, the memory 1202 may further include memories remotely disposed relative to the processor 1204, and the remote memories may be connected to a terminal through a network. Examples of the network include but are not limited to an internet, an intranet, a local area network, a mobile communication network, and a combination thereof. The memory 1202 may be specifically configured, but not limited, to store information such as an image sequence. As an example, as shown in FIG. 12, the memory 1202 may include but is not limited to the obtaining module 1002, the processing module 1004, and the determining module 1006 in the image sequence detection apparatus. In addition, the memory may further include but is not limited to another module unit in the image sequence detection apparatus. Details are not described in this example again.

In some embodiments, a transmission apparatus 1206 is configured to receive or transmit data via a network. Specific examples of the network include a wired network and a wireless network. In an example, the transmission apparatus 1206 includes a network interface controller (NIC) that may be connected to another network device and a router by using a network cable, to communicate with the Internet or a local area network. In an example, the transmission apparatus 1206 is a radio frequency (RF) module, which is configured to communicate with the Internet in a wireless manner.

In addition, the electronic device further includes: a display 1208, configured to display the image sequence; and a connection bus 1210, configured to connect each module component in the electronic device.

In another embodiment, the terminal or server may be a node in a distributed system. The distributed system may be a blockchain system. The blockchain system may be a distributed system formed by connecting a plurality of nodes in a network communication form. A peer to peer (P2P) network may be formed between nodes. Any form of computing device, such as the server, the terminal, and another electronic device, may join the peer-to-peer network as a node in the blockchain system.

According to an aspect of this application, there is provided a computer-readable storage medium. A processor of a computer device reads computer instructions from the computer-readable storage medium. The processor executes the computer instructions, so that the computer device performs the image sequence detection method provided in the various exemplary implementations of image sequence detection.

In this embodiment, the computer-readable storage medium may be configured to store a computer program for performing the following operations:
S1: Obtain an initial image sequence, the initial image sequence including a target object.
S2: Input the initial image sequence to a pretrained target detection model, to obtain a detection result sequence, the target detection model being a detection model obtained by inputting sample training data to an initial detection model to be trained for training, the sample training data including one set of sample feature information respectively extracted from one set of sample images, and a classification result and an evaluation parameter that correspond to each piece of sample feature information, the classification result indicating a classification category for one piece of sample feature information, the evaluation parameter indicating a reward corresponding to the classification category, the one set of sample images being one set of continuous frames of images, and for an i^{th} frame of sample image in the one set of continuous frames of images, sample feature information of the i^{th} frame of sample image being jointly determined based on the i^{th} frame of sample image and an (i−1)^{th} frame of sample image.
S3: Determine a detection result corresponding to each image in the initial image sequence based on the detection result sequence, the detection result being configured for indicating a category of the target object.

An embodiment of this application further provides a computer program product including a computer program that, when run on a computer, enables the computer to perform the method described in the embodiments.

In this embodiment, a person of ordinary skill in the art may understand that all or some operations in the method of the embodiments may be performed by a program instructing hardware of the terminal. The program may be stored in a computer-readable storage medium. The storage medium may include a flash drive, a read-only memory (ROM), a random access memory (RAM), a magnetic disk, and an optical disc.

The sequence numbers of the embodiments of this application are merely for description and do not represent superiority-inferiority of the embodiments.

When the integrated unit in the embodiments is implemented in a form of a software functional unit and sold or used as an independent product, the integrated unit may be stored in the computer-readable storage medium. Based on such an understanding, the technical solutions of this application essentially, or a part contributing to the related art, or all or a part of the technical solution may be implemented in a form of a software product. The computer software product is stored in a storage medium and includes several instructions for instructing one or more computer devices (which may be a PC, a server, a network device, or the like) to perform all or some of the operations of the method in the embodiments of this application.

In the embodiments of this application, the descriptions of the embodiments have respective focuses. For a part that is not described in detail in an embodiment, refer to related descriptions in other embodiments.

In the several embodiments provided in this application, the disclosed client may be implemented in another manner. The described apparatus embodiments are merely examples. For example, division into the units is merely logical function division. There may be another division manner during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the units or modules may be implemented in electrical or other forms.

The units described as separate parts may or may not be physically separate, and parts displayed as units may or may not be physical units, and may be located in one position, or may be distributed on a plurality of network units. Some or all of the units may be selected based on actual requirements, to achieve the objectives of the solutions of the embodiments.

In addition, functional units in the embodiments of this application may be integrated into one processing unit, each of the units may exist alone physically, or two or more units may be integrated into one unit. The integrated unit may be implemented in a form of hardware, or may be implemented in a form of a software functional unit.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module or unit can be part of an overall module or unit that includes the functionalities of the module or unit. The above descriptions are merely the exemplary implementations of this application. A person of ordinary skill in the art may further make several improvements and modifications without departing from the principle of this application, and these improvements and modifications are also considered to be within the protection scope of this application.

What is claimed is:

1. An image sequence detection method performed by a computer device, the method comprising:
obtaining an initial image sequence, the initial image sequence comprising a target object;
inputting the initial image sequence to a pretrained target detection model, to obtain a detection result sequence; and
determining a detection result corresponding to each image in the initial image sequence based on the detection result sequence, the detection result indicating a category of the target object.

2. The method according to claim 1, wherein the target detection model is obtained by inputting sample training data to an initial detection model to be trained for training, the sample training data comprising one set of sample feature information respectively extracted from one set of sample images, and a classification result and an evaluation parameter that correspond to each piece of sample feature information, the classification result indicating a classification category for one piece of sample feature information, the evaluation parameter indicating a reward corresponding to the classification category, the one set of sample images being one set of continuous frames of images, and for an i^{th} frame of sample image in the one set of continuous frames of images, sample feature information of the i^{th} frame of sample image being jointly determined based on the i^{th} frame of sample image and an (i−1)^{th} frame of sample image.

3. The method according to claim 2, further comprising:
performing a first feature extraction operation on the one set of sample images, to obtain a first set of feature information, feature information in the first set of feature information being in one-to-one correspondence to sample images in the one set of sample images;
performing a second feature extraction operation on the one set of sample images, to obtain a second set of feature information, first feature information in the second set of feature information being in one-to-one correspondence to the sample images in the one set of sample images, and the first feature information of the i^{th} frame of sample image indicating a correlation feature between the i^{th} frame of sample image and the (i−1)^{th} frame of sample image; and
fusing the first set of feature information and the second set of feature information respectively, to obtain the one set of sample feature information.

4. The method according to claim 3, wherein for the i^{th} frame of sample image, the performing a second feature extraction operation on the one set of sample images, to obtain a second set of feature information comprises:
performing an image recognition operation on the i^{th} frame of sample image, to determine a first set of key points, the first set of key points being configured for describing a location of the target object in the i^{th} frame of sample image;
performing an image recognition operation on the (i−1)^{th} frame of sample image, to determine a second set of key points, the second set of key points being configured for describing a location of the target object in the (i−1)^{th} frame of sample image; and
determining the first feature information of the i^{th} frame of sample image based on the first set of key points and the second set of key points, the first feature information of the i^{th} frame of sample image being configured for indicating a distance between corresponding key points in the first set of key points and the second set of key points.

5. The method according to claim 2, wherein for the i^{th} frame of sample image, the method further comprises:
inputting the sample feature information of the i^{th} frame of sample image to the initial detection model, to obtain a classification result for the i^{th} frame of sample image, the initial detection model being a detection model obtained by performing an initialization operation in advance; and
determining an evaluation parameter for the i^{th} frame of sample image based on the classification result for the i^{th} frame of sample image and a classification category corresponding to the sample feature information of the i^{th} frame of sample image, the evaluation parameter for the i^{th} frame of sample image being configured for indicating whether the classification result for the i^{th} frame of sample image is the same as the corresponding classification category.

6. The method according to claim 5, wherein the inputting the sample feature information of the i^{th} frame of sample image to the initial detection model, to obtain a classification result for the i^{th} frame of sample image comprises:
inputting each category in a preset category set to a first preset function in sequence with the sample feature information of the i^{th} frame of sample image, to obtain a first set of function values, the first set of function values comprising a function value for each category relative to the sample feature information of the i^{th} frame of sample image; and
determining, as the classification result for the i^{th} frame of sample image, a candidate category corresponding to a first function value in the first set of function values that is the largest.

7. The method according to claim 6, wherein before the inputting each category in a preset category set to a first preset function in sequence with the sample feature information of the i^{th} frame of sample image, to obtain a first set of function values, the method further comprises:
calculating a target random number in a preset manner;
determining whether the target random number satisfies a preset probability condition; and
selecting a candidate category randomly from the preset category set as the classification result for the i^{th} frame of sample image when the target random number satisfies the preset probability condition; or
performing the operation of inputting each category in a preset category set to a first preset function in sequence with the sample feature information of the i^{th} frame of sample image, to obtain a first set of function values, when the target random number does not satisfy the preset probability condition.

8. The method according to claim 6, wherein the determining, as the classification result for the i^{th} frame of sample image, a candidate category corresponding to a first function value in the first set of function values that is the largest comprises:
determining the evaluation parameter for the i^{th} frame of sample image as a first evaluation parameter when the candidate category corresponding to the first function value is the same as the classification category for the i^{th} frame of sample image, the first evaluation parameter indicating correct detection of the initial detection model; or
determining the evaluation parameter for the i^{th} frame of sample image as a second evaluation parameter when the candidate category corresponding to the first function value is different from the classification category for the i^{th} frame of sample image, the second evaluation parameter indicating incorrect detection of the initial detection model.

9. The method according to claim 2, wherein the target detection model is obtained by:
selecting a plurality of sample data structures from the sample training data, a j^{th} sample data structure in the plurality of sample data structures comprising a j^{th} piece of sample feature information, a j^{th} classification result corresponding to the j^{th} piece of sample feature information, a j^{th} evaluation parameter, and a (j+1)^{th} piece of sample feature information, and j being a positive integer; and
training the initial detection model to be trained based on the plurality of sample data structures, to obtain the target detection model, the initial detection model being determined as the target detection model when a round count of training the initial detection model reaches a preset round count threshold, or a model parameter of the initial detection model being adjusted based on a predetermined loss function when a round count of training the initial detection model does not reach the preset round count threshold, and an input for a training process of each round being one of the plurality of sample data structures.

10. The method according to claim 9, wherein for the j^{th} sample data structure, the training the initial detection model to be trained based on the plurality of sample data structures, to obtain the target detection model comprises:
determining whether a sample image corresponding to the (j+1)^{th} piece of sample feature information is a last sample image in the sample image sequence;
determining, based on the j^{th} evaluation parameter when the sample image corresponding to the (j+1)^{th} piece of sample feature information is the last sample image, a preset parameter outputted by the initial detection model; or
determining the preset parameter based on the j^{th} evaluation parameter and an output of a reference detection model when the sample image corresponding to the (j+1)^{th} piece of sample feature information is not the last sample image, the reference detection model being a detection model obtained by performing an initialization operation in advance, and a parameter of the reference detection model being different from a parameter of the initial detection model;
determining a value of the loss function based on the preset parameter and an output of the initial detection model, and updating the parameter of the initial detection model based on the value of the loss function; and
determining the initial detection model as the target detection model when a round count of performing the above operations reaches the preset round count threshold.

11. An electronic device, comprising a memory and a processor, the memory having computer programs stored therein, and the computer programs, when executed by the processor, causing the electronic device to perform an image sequence detection method including:
obtaining an initial image sequence, the initial image sequence comprising a target object;
inputting the initial image sequence to a pretrained target detection model, to obtain a detection result sequence; and
determining a detection result corresponding to each image in the initial image sequence based on the detection result sequence, the detection result indicating a category of the target object.

12. The electronic device according to claim 11, wherein the target detection model is obtained by inputting sample training data to an initial detection model to be trained for training, the sample training data comprising one set of sample feature information respectively extracted from one set of sample images, and a classification result and an evaluation parameter that correspond to each piece of sample feature information, the classification result indicating a classification category for one piece of sample feature information, the evaluation parameter indicating a reward corresponding to the classification category, the one set of sample images being one set of continuous frames of images, and for an i^{th} frame of sample image in the one set of continuous frames of images, sample feature information of the i^{th} frame of sample image being jointly determined based on the i^{th} frame of sample image and an (i−1)^{th} frame of sample image.

13. The electronic device according to claim 12, wherein the method further comprises:
performing a first feature extraction operation on the one set of sample images, to obtain a first set of feature information, feature information in the first set of feature information being in one-to-one correspondence to sample images in the one set of sample images;
performing a second feature extraction operation on the one set of sample images, to obtain a second set of feature information, first feature information in the second set of feature information being in one-to-one correspondence to the sample images in the one set of sample images, and the first feature information of the i^{th} frame of sample image indicating a correlation feature between the i^{th} frame of sample image and the (i−1)^{th} frame of sample image; and
fusing the first set of feature information and the second set of feature information respectively, to obtain the one set of sample feature information.

14. The electronic device according to claim 13, wherein for the i^{th} frame of sample image, the performing a second feature extraction operation on the one set of sample images, to obtain a second set of feature information comprises:
performing an image recognition operation on the i^{th} frame of sample image, to determine a first set of key points, the first set of key points being configured for describing a location of the target object in the i^{th} frame of sample image;
performing an image recognition operation on the (i−1)^{th} frame of sample image, to determine a second set of key points, the second set of key points being configured for describing a location of the target object in the (i−1)^{th} frame of sample image; and
determining the first feature information of the i^{th} frame of sample image based on the first set of key points and the second set of key points, the first feature information of the i^{th} frame of sample image being configured for indicating a distance between corresponding key points in the first set of key points and the second set of key points.

15. The electronic device according to claim 12, wherein for the i^{th} frame of sample image, the method further comprises:
inputting the sample feature information of the i^{th} frame of sample image to the initial detection model, to obtain a classification result for the i^{th} frame of sample image, the initial detection model being a detection model obtained by performing an initialization operation in advance; and
determining an evaluation parameter for the i^{th} frame of sample image based on the classification result for the i^{th} frame of sample image and a classification category corresponding to the sample feature information of the i^{th} frame of sample image, the evaluation parameter for the i^{th} frame of sample image being configured for indicating whether the classification result for the i^{th} frame of sample image is the same as the corresponding classification category.

16. The electronic device according to claim 15, wherein the inputting the sample feature information of the i^{th} frame of sample image to the initial detection model, to obtain a classification result for the i^{th} frame of sample image comprises:
inputting each category in a preset category set to a first preset function in sequence with the sample feature information of the i^{th} frame of sample image, to obtain a first set of function values, the first set of function values comprising a function value for each category relative to the sample feature information of the i^{th} frame of sample image; and
determining, as the classification result for the i^{th} frame of sample image, a candidate category corresponding to a first function value in the first set of function values that is the largest.

17. The electronic device according to claim 12, wherein the target detection model is obtained by:
selecting a plurality of sample data structures from the sample training data, a j^{th} sample data structure in the plurality of sample data structures comprising a j^{th} piece of sample feature information, a j^{th} classification result corresponding to the j^{th} piece of sample feature information, a j^{th} evaluation parameter, and a (j+1)^{th} piece of sample feature information, and j being a positive integer; and
training the initial detection model to be trained based on the plurality of sample data structures, to obtain the target detection model, the initial detection model being determined as the target detection model when a round count of training the initial detection model reaches a preset round count threshold, or a model parameter of the initial detection model being adjusted based on a predetermined loss function when a round count of training the initial detection model does not reach the preset round count threshold, and an input for a training process of each round being one of the plurality of sample data structures.

18. The electronic device according to claim 17, wherein for the j^{th} sample data structure, the training the initial detection model to be trained based on the plurality of sample data structures, to obtain the target detection model comprises:
determining whether a sample image corresponding to the (j+1)^{th} piece of sample feature information is a last sample image in the sample image sequence;
determining, based on the j^{th} evaluation parameter when the sample image corresponding to the (j+1)^{th} piece of sample feature information is the last sample image, a preset parameter outputted by the initial detection model; or
determining the preset parameter based on the j^{th} evaluation parameter and an output of a reference detection model when the sample image corresponding to the (j+1)^{th} piece of sample feature information is not the last sample image, the reference detection model being a detection model obtained by performing an initialization operation in advance, and a parameter of the reference detection model being different from a parameter of the initial detection model;
determining a value of the loss function based on the preset parameter and an output of the initial detection model, and updating the parameter of the initial detection model based on the value of the loss function; and
determining the initial detection model as the target detection model when a round count of performing the above operations reaches the preset round count threshold.

19. A non-transitory computer-readable storage medium, comprising computer programs therein, wherein the computer programs, when executed by a processor of an electronic device, cause the electronic device to perform an image sequence detection method including:
obtaining an initial image sequence, the initial image sequence comprising a target object;
inputting the initial image sequence to a pretrained target detection model, to obtain a detection result sequence; and
determining a detection result corresponding to each image in the initial image sequence based on the detection result sequence, the detection result indicating a category of the target object.

20. The non-transitory computer-readable storage medium according to claim 19, wherein the target detection model is obtained by inputting sample training data to an initial detection model to be trained for training, the sample training data comprising one set of sample feature information respectively extracted from one set of sample images, and a classification result and an evaluation parameter that correspond to each piece of sample feature information, the classification result indicating a classification category for one piece of sample feature information, the evaluation parameter indicating a reward corresponding to the classification category, the one set of sample images being one set of continuous frames of images, and for an i^{th} frame of sample image in the one set of continuous frames of images, sample feature information of the i^{th} frame of sample image being jointly determined based on the i^{th} frame of sample image and an (i−1)^{th} frame of sample image.
